(19) United States
(12) Patent Application Publication
(10) Pub. No.: US 2008/0252160 A1
(43) Pub. Date: Oct. 16, 2008

(54) Connecting Plate for Electric Motor and Electric Motor

(75) Inventors: Michal Kavalsky, Kosice (SK); Robert Valo, Michalovce (SK)

Correspondence Address: LERNER GREENBERG STEMER LLP, P O BOX 2480, HOLLYWOOD, FL, 33022-2480, US

(73) Assignee: BSH BOSCH UND SIEMENS HAUSGERÄTE GMBH, Munich (DE)

(21) Appl. No.: 12/088,605

(22) PCT Filed: Sep. 28, 2006
(86) PCT No.: PCT/EP06/66823

§ 371 Date: Apr. 29, 2008

(30) Foreign Application Priority Data
Sep. 29, 2005 (DE) DE102005046759.8

(51) Int. Cl. H02K 11/00; H01R 13/73; H01R 13/66

(52) U.S. Cl. 310/71; 439/571; 439/620.22; 310/68 B

(57) ABSTRACT

A connecting plate for an electric motor has at least one receptacle area with at least one receptacle opening for one or more sensors for monitoring the rotor position. Furthermore, an electric motor which has such a connecting plate is described. With the novel device it is possible to simplify the manufacture of the electric motor, and in particular to minimize the length of the connecting lines to the sensors by integrating the sensor holder into the connecting plate.

The present invention relates to a connecting plate for an electric motor and to an electric motor.

Particularly in some electrically commutated motors with a magnetic rotor or a permanent magnet in the rotor, one or more sensors are provided which are used to detect the position of the rotor relative to the stator field. This variable is essential in order to be able to control the stator currents as a function of the rotor position, thereby enabling maximum motor torque to be achieved.

These sensors and the necessary electrical components are generally provided on a small printed circuit board which will hereinafter also be referred to as a PCB. This PCB or more specifically the sensors on the PCB are mounted between the stator teeth, i.e. the stator poles, in order to be able to detect the magnetic field of the rotor magnets. Alternatively, the PCB is provided with the sensors on the end shield in plastic holders specially provided for the purpose in order to detect the field of an additional magnetic ring provided on the shaft outside the motor or more specifically the motor housing. In both cases the sensors provided on the PCB must be connected to control electronics elements via relatively long connecting lines.

The disadvantage of the known solutions is that large tolerances in detecting the rotor position must be accepted. In addition, a large number of motor parts are required. For example, in particular the holders for the sensors and corresponding fixing screws must be provided.

The object of the invention is to eliminate these disadvantages and in particular provide a motor component of simple construction.

The invention is based on the recognition that this object can be achieved by extending the functionality of a component generally provided in an electric motor.

This object is thus achieved according to a first aspect by a connecting plate for an electric motor, said connecting plate being characterized in that it has at least one mounting area with at least one mounting hole for at least one sensor for monitoring the rotor position.

Within the scope of this invention, the connecting plate, which will hereinafter also be called the terminal, refers to the internal terminal plate via which the wires of the stator windings can be connected. Said internal connecting plate may comprise an external terminal to which the external lines are connected or it can be connected thereto via a plug-in connection. The inventive implementation of the connecting plate means that it can be used both for contacting the coil windings and as a support and fixing for sensors. Incorporation of the sensor holder in the connecting plate obviates the need for a separate sensor holding device which would generally required screws and other components. The mounting hole in the mounting area can be used in particular for guiding the sensors through it. In addition, the mounting holes can be provided with a flange or web which protects the sensor guided through the mounting hole at least from one side.

By providing at least one mounting hole in the connecting plate and the sensors being able to point to the side facing away from the mounting area, lines can be routed from the sensors or rather from the PCB to contacts and/or control electronics on the side of the connecting plate facing away from the sensors and therefore the stator. This means that the PCB can be protected by an end shield provided on the motor.

According to one embodiment, the mounting area has at least one recess for accommodating a printed circuit board. This printed circuit board (PCB), which can be used for contacting the sensors and can also carry sensor system elements, can therefore be retained in a protected position and the position of the PCB can be predetermined by the recess.

The connecting plate is preferably L-shaped, there being provided in one leg at least the mounting area and in the other leg at least the contacts for connecting or more specifically contacting the coil windings of the electric motor. In this way the contacts can be disposed on the edge of the stator where the connecting plate can be brought into direct connection, i.e. without wires, with an external terminal. In addition, the mounting area can extend over the end face of the stator, thereby enabling the sensors to be reliably positioned at the location at which they are to monitor or more specifically detect the position of the rotor.

On the leg in which the contacts are provided, there can be additionally provided at least one fixing element for attaching the connecting plate to the stator, in particular to the stator assembly. Said fixing element enables the connecting plate to be fixed directly to the stator and because of the incorporation of the sensor holder in the connecting plate therefore also allows the position of the sensors to be precisely defined. This type of connecting plate and its fixing to the stator enables rotor position detection tolerances to be eliminated.

The mounting area of the connecting plate preferably covers part of the circumference of the stator end face. In contrast to a device which covers the entire end face of the stator, this embodiment has a simplified construction. Material is only required to form the mounting area in which the PCB can be accommodated.

According to one embodiment, the mounting area holds a circuit board which has at least one contact plug for establishing contact with or connecting to the contacts of the connecting plate. This arrangement completely eliminates the need for separate connecting wires for the sensors which are likewise disposed on the PCB. In addition, only one type of connection is implemented in the entire component, as the stator windings can also be contacted via corresponding contact plugs.

Alternatively there can be provided in the mounting area at least one guide for a connecting line between a printed circuit board and the at least one contact. This guide can be implemented by partition walls in the recess of the mounting area. Connecting lines provided on the PCB can run in these guides and therefore be protected.

According to another aspect, the invention relates to an electric motor, in particularly a commutated electric motor, with a stator, a rotor and at least one sensor for detecting the rotor position. The electric motor is characterized in that it comprises at least one connecting plate having at least one mounting area with at least one mounting hole for the at least one sensor. The inventive connecting plate enables the electric motor to have a simpler construction than conventional electric motors. In particular, separate fixing devices for holding the sensors can be dispensed with.

According to one embodiment, the electric motor has a magnetic ring between the rotor and a bearing supporting an end shield. In the inventive embodiment of the motor, said magnetic ring used for monitoring the rotor position can be provided inside the motor housing, as the sensors are integral with the stator connecting plate. This mounting location of the magnetic ring reduces the overall length of the electric motor compared to conventional motors in which the magnetic ring is provided outside the end shield.

On the outer circumference of the stator assembly there is preferably provided in the electric motor according to the invention at least one fixing cutout for fixing at least one connecting plate. Said fixing cutout in particular constitutes a slot into which part of the connecting plate can be inserted, thereby fixing the stop of the connecting plate and therefore the position of the sensors.

Advantages and features described with reference to the connecting plate also hold true—where applicable—for the inventive electric motor and vice versa.

The present invention will now be explained again in detail with reference to the accompanying drawings in which:

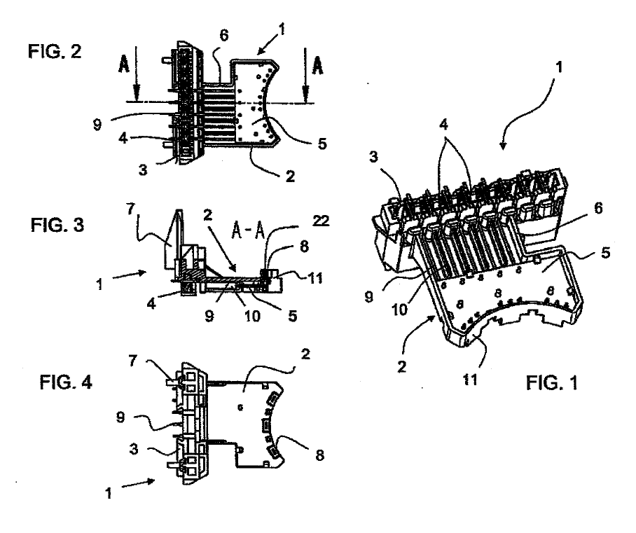

FIG. 1: shows a schematic perspective view of an embodiment of the connecting plate;

FIG. 2: shows a top view onto the connecting plate illustrated in FIG. 1;

FIG. 3: shows a section view through the connecting plate illustrated in FIG. 1 along the intersection line A-A in FIG. 2;

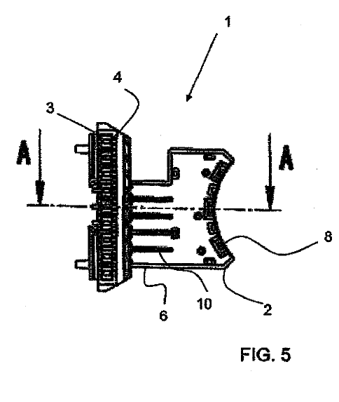

FIG. 4: shows a bottom view of the connecting plate illustrated in FIG. 1;

FIG. 5: shows a top view of an embodiment of the inventive connecting plate without printed circuit board;

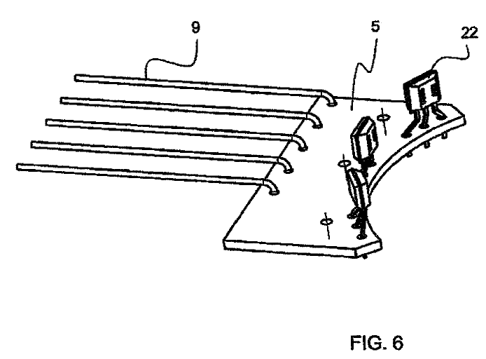

FIG. 6: shows a schematic perspective view of the first embodiment of the printed circuit board with connections and sensors;

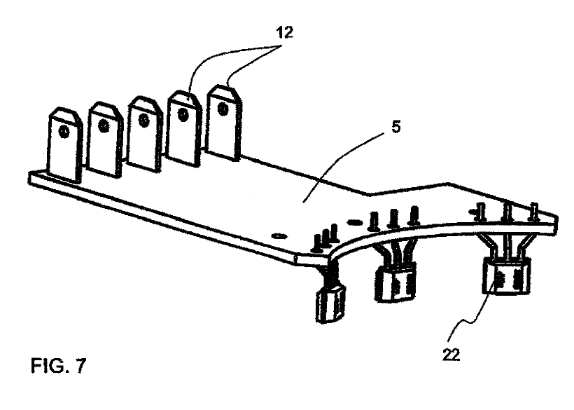

FIG. 7: shows a schematic perspective view of another embodiment of the printed circuit board with connections and sensors;

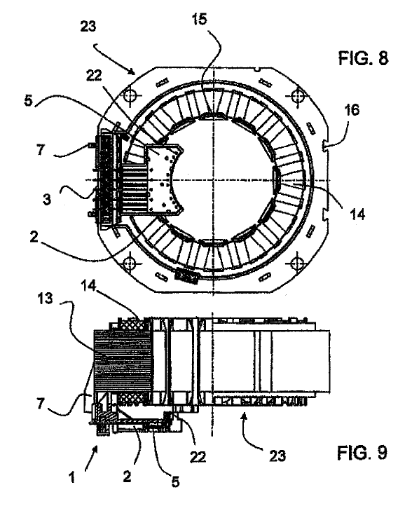

FIG. 8: shows a top view of the stator design of an electric motor with connecting plate;

FIG. 9: shows a partial sectional view of the design from FIG. 8;

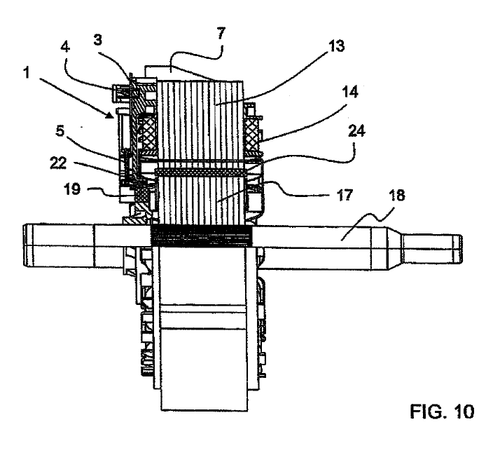

FIG. 10: shows a schematic partial sectional view of a stator-rotor design with rotor shaft;

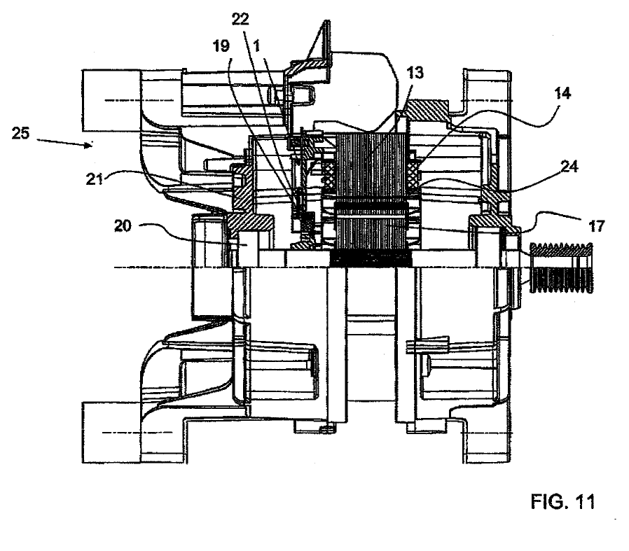

FIG. 11: shows a schematic partial sectional view of the stator-rotor design from FIG. 10 with housing;

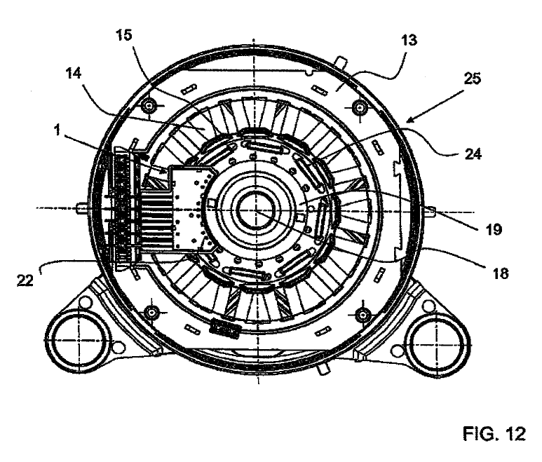

FIG. 12: shows a schematic top view of the stator-rotor design from FIG. 11;

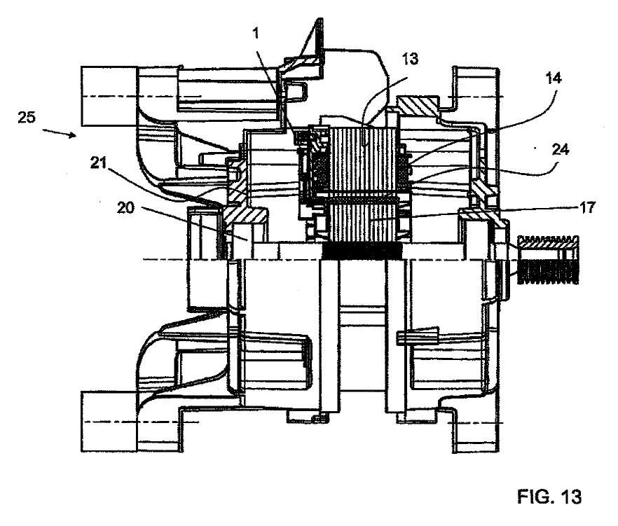

FIG. 13: shows a schematic partial sectional view of another embodiment of the data-rotor design with housing; and

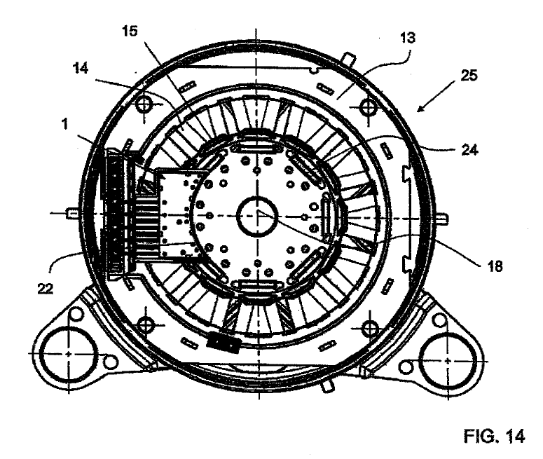

FIG. 14: shows a schematic top view of the stator-rotor design from FIG. 13.

FIG. 1 shows a perspective view of a connecting plate 1. The connecting plate 1 consists of a mounting area 2 and a contact area 3. In the contact area 3, contacts 4 are provided via which electrical connection of the coil windings of the stator of an electric motor can be established using leads (not shown). The mounting area 2 is essentially trough-shaped, the indented recess in the front area, i.e. in the part of the mounting area 2 spaced away from the contract area 3, being used to accommodate a printed circuit board (PCB) 5. Between this part of the mounting area 2 and the contact area 3, a connecting section 6 is provided which constitutes part of the mounting area 2. Said connecting section 6 contains partition walls 10 which extend into the trough shape and enclose connecting lines 9 from the PCB 5 which run to the contacts 4 in the contact area 3 of the connecting plate 1.

As illustrated particularly in FIG. 2 which shows a top view onto the connecting plate 1, the front region of the mounting area 2 is wider than the connecting section 6. On the end of the mounting area 2 facing away from the contact area 3, the mounting area has a curved section along which the mounting holes or rather passage openings 8 for sensors 22 are provided. In the embodiment shown, three mounting holes 8 are provided. The disposition of the sensors 22 and the PCB 5 in the mounting area 2 can be seen from FIG. 3 which shows the mounting holes 8 and, adjacent thereto, the protective wall 11 for the sensors 22. The distribution of the mounting holes 8 along the edge of the mounting area 2 is particularly clear from FIG. 4. Due to the position of the mounting holes 8, the positions of the sensors 22 are unambiguously predefined so that positioning inaccuracies during population of the PCB 5 can be compensated.

As FIG. 3 also shows, two fixing wedges 7 are provided on the contact area 3 which constitutes one leg of the essentially L-shaped connecting plate 1. Via said fixing wedges 7, the connecting plate 1 can be mounted to a stator assembly 13, as will be explained in greater detail below.

FIG. 5 shows a top view onto a connecting plate 1 without PCB 5. Visible in this view are the partition walls 10 in the connecting section 6 which connects the front region of the mounting area 2 and the contact area 3. By means of these partition walls 10, guides for the connecting lines 9 of the PCB 5 are formed.

FIG. 6 shows the disposition of the sensors 22 on the PCB 5 according to one embodiment. As this FIG. 6 shows, the sensors 22 project upward in one direction from the PCB 5. The connecting lines 9 are mounted to the PCB 5 in the same direction. This PCB 5 can be placed in the mounting area 2 of the connecting plate 1 with the sensors 22 projecting through the mounting holes 8 in the mounting area 2 and being able to be contacted by means of the connecting lines 9 in the contact area 3 via conventional connection means. The PCB 5 shown in FIG. 6 with the sensors 22 in place can therefore be completely accommodated in the mounting area 2 of the connecting plate 1, the length of a connecting lines 9 corresponding only to the length of the connecting section 6 and the contact area 3, and these short connecting lines 9 also being securely routed by means of the mounting area 2 and the partition walls 10 provided therein.

FIG. 7 shows another embodiment of the PCB 5. Here the latter has a shape corresponding to the entire mounting area 2 of the connecting plate 1. In particular, in this embodiment the PCB 5 also extends over the connecting section 6 and fills it up. Partition walls 10 are not required when using such a PCB 5. On the end of the PCB 5 facing the contact area 3, contact plugs 12 are provided which are soldered to the PCB 5. These contact plugs 12 can be connected to contacts 4 in the contact area 3 or can be inserted therein.

The attachment of the connecting plate 1 to the stator arrangement 23 of an electric motor is shown in FIG. 9. The connecting plate 1 is inserted in stator slots 16 appropriately provided for that purpose by means of the fixing wedges 7. In the mounted position, the contact area 3 therefore lies at the edge of the stator assembly 13 and is therefore accessible for connection to a so-called external terminal without the use of wires and the like. In addition, the mounting area 2 of the connecting plate 1 extends radially and essentially parallel to the end face of the stator assembly 13. Because of the length of the mounting area 2, in the embodiment shown the sensors 22 are disposed so as to be spaced radially in an inwardly offset manner from the inner edge of the stator 23, in particular of the stator poles 15.

FIG. 9 shows a partial cross-section through the stator arrangement 23 from FIG. 8. As illustrated here, the connecting plate 1 is fixed to the stator assembly 13 via the fixing wedges 7. The mounting area is spaced away from the end face of the stator 23, the PCB 5 facing away from the stator or being separated from same by the mounting area 2. The sensors 22 extend through the mounting holes 8 in the direction of the stator 23.

FIG. 10 shows a partial cross-section through a stator arrangement 23 having a rotor 17 with rotor shaft 18 mounted therein. The rotor magnets or more specifically poles 24 are provided in the rotor 17. In front of the rotor 17 there is provided on the rotor shaft 18 a magnetic ring 19 which has a smaller diameter than the rotor 17, said magnetic ring 19 possessing a number of poles corresponding to the rotor assembly 17. The mounting area 2 of the connecting plate 1 provided on the stator assembly 13 extends from the contact area 3 to the outer circumference of the magnetic ring 19. This means that the sensors 22 of the PCB 5 accommodated in the mounting area 2 are directly adjacent to the magnetic ring 19, thereby enabling them to detect the rotor position.

FIG. 11 shows this stator-rotor arrangement in the housing, which comprises in particular an end shield 21. Said end shield 21 is mounted on the rotor shaft 18 via the bearing 20. The magnetic ring 19 disposed in front of the rotor 17 is therefore between the rotor 17 and the end shield 21. As the magnetic ring 19 can be accommodated in the housing on a free piece of the rotor shaft 18, the motor 25 thus formed has a low overall length

The top view onto this embodiment of the electric motor 25 shown in FIG. 12 illustrates on the one hand the stator windings 14. Also indicated is the position of the magnetic ring 19 and the main rotor poles, i.e. rotor magnets 24, provided in the rotor 17, the sensors 22 which are carried on the PCB 5 provided in the mounting area 2 being located between the magnets 24 of the rotor 17 and the magnetic ring 19.

In the further embodiment shown in FIG. 13, the position of the rotor 17 is determined via the sensors 22, by monitoring of the main rotor poles 24. In this case the sensors 22 are aligned with the poles 24 of the rotor 17. As can be seen from the top view in FIG. 14, this alignment is achieved by selecting the length of the mounting area 2. In the embodiment shown, the mounting area 2 extends from the contact area 3 only as far as the magnet poles 24 of the rotor 17, which means that the mounting holes 8 in the connecting plate 1 in which the sensors 22 are mounted correspond to the position of the magnets. In this embodiment a separate magnetic ring is not provided.

With the present invention it is possible to achieve sensor positioning with minimal tolerances between the stator assembly and the motor end shield as well as between the motor end shield and plastic sensor holders. The invention permits minimal tolerance between the stator teeth, i.e. the stator poles, and the sensor or sensors. The invention also offers extremely short connecting lines for connecting the sensors to the contact area of the internal connecting plate. In addition, with the invention two functions can be incorporated in one motor component, namely the connecting plate function and the sensor holder function. No screws are necessary for fixing the sensor holder to the motor and, in addition, mechanical protection can be provided for the sensor holder, sensors and PCB by the motor end shield. The invention also allows a shorter shaft to be used for the motor, as a magnetic ring can be provided on a free section of the rotor shaft between the bearing and the rotor assembly. Lastly, the total number of motor connecting plates, contact types for motor connecting plates, screws for fixing the holder and plastic parts can be reduced by incorporating the sensor holder in the internal motor connecting plate.

1-10. (canceled)

11. A connecting plate for an electric motor having a rotor and coil windings, the connecting plate comprising:
an L-shaped connecting plate body formed with a first leg and with a second leg;
at least one mounting area formed on said first leg, said at least one mounting area having at least one mounting hole formed therein for receiving at least one sensor for monitoring a rotor position of the rotor of the electric motor; and
contacts for contacting the coil windings of the electric motor disposed on said second leg of said connecting plate body.

12. The connecting plate according to claim 11, wherein said mounting area is formed with at least one recess for accommodating a printed circuit board.

13. The connecting plate according to claim 12, wherein said printed circuit board includes at least one contact plug for contacting with said contacts.

14. The connecting plate according to claim 11, which further comprises at least one fixing element for fixing said connecting plate body to a stator of the electric motor, disposed together with said contacts on said second leg.

15. The connecting plate according to claim 11, wherein said mounting area is disposed to cover a portion of a stator end face.

16. The connecting plate according to claim 11, which further comprises a printed circuit board mounted on said mounting area, said printed circuit board having at least one contact plug for contacting with said contacts.

17. The connecting plate according to claim 16, wherein said mounting area is formed with at least one guide for a connecting line between said printed circuit board and said contacts.

18. The connecting plate according to claim 11, wherein said mounting area is provided with at least one guide for a connecting line between a printed circuit board and said contacts.

19. An electric motor, comprising:
a stator, a rotor, and at least one sensor disposed for detecting a rotor position of said rotor; and
at least one connecting plate according to claim 10 carrying said at least one sensor in said at least one mounting hole.

20. The electric motor according to claim 19, which further comprises a magnetic ring disposed between said rotor and a bearing supporting an end shield.

21. The electric motor according to claim 19, wherein an outer circumference of a stator assembly is formed with at least one fixing cutout for mounting thereto at least one connecting plate.
